(19) United States
(12) Patent Application Publication
(10) Pub. No.: US 2011/0035191 A1
(43) Pub. Date: Feb. 10, 2011

(54) METHOD AND DEVICE FOR CALCULATING QUALITY-VALUE OF IN-BUILDING MOBILE COMMUNICATION SERVICE

(75) Inventors: Jin-Yeol Roh, Seoul (KR); Chang-Yong Ahn, Seoul (KR); Young-Tae Lee, Seoul (KR); Seok-Young Kong, Seoul (KR); Jong-Shin Lee, Seoul (KR)

Correspondence Address: KNOBBE MARTENS OLSON & BEAR LLP, 2040 MAIN STREET, FOURTEENTH FLOOR, IRVINE, CA, 92614, US

(73) Assignee: KT Coporation, Seoul (KR)

(21) Appl. No.: 12/906,943

(22) Filed: Oct. 18, 2010

Related U.S. Application Data
(63) Continuation of application No. PCT/KR2008/002185, filed on Apr. 17, 2008.

(51) Int. Cl. G06F 17/50; G06F 3/048

(52) U.S. Cl. 703/1; 715/810

(57) ABSTRACT

A method of calculating a quality-value of a mobile communication service is disclosed. In one embodiment, the method includes i) loading an engineering design of the building into a memory of a computing device having a graphic user interface (GUI), ii) applying an engineering factor which influences a quality of the mobile communication service on the engineering design when a communication device, configured to provide the mobile communication service, is set up in the building; and iii) calculating, with a processor of the computing device, the quality-value of the mobile communication service based on the applied engineering factor.

### CROSS-REFERENCE TO RELATED APPLICATIONS

This application is a continuation application, and claims the benefit under 35 U.S.C. §§120 and 365 of PCT Application No. PCT/KR2008/002185, filed on Apr. 17, 2008, which is hereby incorporated by reference.

### BACKGROUND

1. Field

The described technology generally relates to a method and an apparatus for calculating a quality-value of a mobile communication service, more specifically to method and apparatus for calculating a quality-value of a mobile communication service in a building.

2. Description of the Related Technology

Approximately 70% of the traffic of mobile communication occurs in a building and 90% of data application is executed in a building. Providing a proper mobile communication service has a direct effect on subscribers' evaluation of the mobile communication service in the building, and therefore it heavily affects a profit of a mobile communication service provider.

To provide a proper mobile communication service, a repeater is set up. The repeater relays and amplifies a weak signal of a base station to provide the mobile communication service to a shadow area of microwave mobile communication in the building. Therefore, the repeater has a great influence on the quality of the mobile communication service performed in the building.

In the case of setting up a repeater in the building, many factors are considered for setting in low cost and high efficiency. Considerable factors are the internal structure of a building, a type of a repeater, a type of a cable, a type of a distributor, a type of a antenna, an external signal and so on.

The aforementioned factors have been mainly considered by an engineer's subjective insight. The quality of the mobile communication service performed in the building heavily depends on how much the engineer is skilled, how much important the considerable factors are, what view point of engineering the engineer has and how much the engineering factors are understood, when the repeater is set up.

Also, the engineer sets up the repeater in consideration of the aforementioned factors, but the engineer is not able to estimate and expect the quality of the mobile communication service accurately. Therefore, after setting up the repeater, ununiformity or lack of a mobile communication service coverage causes additional equipments to be required and additional costs to be spent,

Also, since the engineers or field service technicians can not estimate the quality of the mobile communication service accurately, an over coverage of the mobile communication service may be computed. This results in raising the investment cost.

Furthermore, according to the change of a signal of an external base station or the change of an internal structure of the building, the coverage that the repeater can cover in the building may be changed. In this case, to check the coverage covered in the building, the engineer must perform the field service. Also, the various factors considered when setting up a first repeater must be considered again to check the storage, This may cause the workload to be increased.

Moreover, the initial intention of the engineering can be changed by the alternation of the engineer, which results in setting up the repeaters in the building inconsistently.

So far, in the case of setting up the repeater in the building, the engineers or the field service technicians engineer or set up the repeater depending on their experience with a lot of aforementioned problems.

### SUMMARY OF CERTAIN INVENTIVE ASPECTS

One inventive aspect can check the capability of the equipment set up in a pertinent place and allocate the optimal power by visualizing the quality of a mobile communication service in order to efficiently compute the coverage.

Another aspect can estimate the influence on the change of the capability of a repeater, a building's internal structure and various other devices in order to make the easy application depending on how much the surroundings of the mobile communication is changed.

Another aspect can consistently set up repeaters in a building in consideration of various variables such as changeable engineer's engineering methods and design trends.

Another aspect can increase the understanding of an actual field status of a site by visualizing the influence on the change of the mobile communication performance in a building and provide an accurate and quick material for determining whether more equipment is necessary, to thereby manage the building more efficiently.

Another aspect can decrease an engineering error of mobile communication equipment in a building and the possibility of being re-set up due to the lack of the coverages, to thereby reduce the equipment cost.

Another aspect is a method for allowing an apparatus to calculate a quality-value of a mobile communication service in a building

The method can include loading an engineering design of the building on a quality providing GUI; applying an engineering factor influencing a quality of the mobile communication service on the engineering design, when a communication equipment for providing the mobile communication service is set up in the building; and calculating the quality-value of the mobile communication service based on the applied engineering factor.

Another aspect is an apparatus for calculating a quality-value of a mobile communication service.

The apparatus can include a engineering design loading part, configured to load an engineering design of the building on a quality providing GUI; a engineering factor setting part, configured to apply an engineering factor influencing a quality of the mobile communication service on the engineering design, when a communication equipment for providing the mobile communication service is set up in the building; and a mobile communication quality value calculation part, configured to calculate the quality-value of the mobile communication service based on the applied engineering factor.

### BRIEF DESCRIPTION OF THE DRAWINGS

FIG. 1 illustrates a system for providing a quality-value of a mobile communication service in a building in accordance with an embodiment.

FIG. 2 is a block diagram showing an apparatus for calculating a quality value of a mobile communication service in accordance with an embodiment.

FIG. 3 is a flowchart showing a method for calculating a quality-value of a mobile communication service in a building in accordance with an embodiment.

FIG. 4 through FIG. 11 show how a quality value of a mobile communication service is calculated in a building in accordance with an embodiment.

FIG. 12 and FIG. 13 are engineering designs sowing a building where an apparatus for calculating a quality value of a mobile communication service in a building is used in the building in accordance with an embodiment.

### DETAILED DESCRIPTION OF CERTAIN INVENTIVE EMBODIMENTS

Embodiments will be illustrated and described with reference to the accompanying drawings. This, however, is by no means to restrict the present invention to certain embodiments, and shall be construed as including all permutations, equivalents and substitutes covered by the spirit and scope of the present invention. Throughout the drawings, similar elements are given similar reference numerals.

Terms such as “first” and “second” can be used in describing various elements, but the above elements shall not be restricted to the above terms. The above terms are used only to distinguish one element from the other. For instance, the first element can be named the second element, and vice versa, without departing the scope of the claims. The term “and/or” shall include the combination of a plurality of listed items or any of the plurality of listed items.

When one element is described as being “connected” or “accessed” to another element, it shall be construed as being connected or accessed to the other element directly but also as possibly having another element in between. On the other hand, if one element is described as being “directly connected” or “directly accessed” to another element, it shall be construed that there is no other element in between.

The terms used in the description are intended to describe certain embodiments only, and shall by no means are restrictive thereto. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

Unless otherwise defined, all terms, including technical terms and scientific terms, used herein have the same meaning as how they are generally understood by those of ordinary skill in the art to which the invention pertains. Any term that is defined in a general dictionary shall be construed to have the same meaning in the context of the relevant art, and, unless otherwise defined explicitly, shall not be interpreted to have an idealistic or excessively formalistic meaning.

Hereinafter, embodiments will be described in detail with reference to the accompanying drawings. Identical or corresponding elements will be given the same reference numerals, regardless of the figure number, and any redundant description of the identical or corresponding elements will not be repeated. Throughout the disclosure, description of unnecessary elements will be omitted.

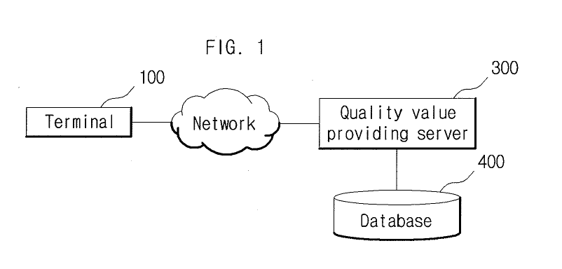

FIG. 1 illustrates a system for providing a quality-value of a mobile communication service in a building in accordance with an embodiment.

As illustrated in FIG. 1, the system includes a quality value providing server 300. The quality value providing server 300 can be connected to a terminal 100 through a network. In a building, the mobile communication service is provided to a subscriber. The quality value, which indicates the quality of a mobile communication service, can be represented by using various communication parameters or a combination thereof.

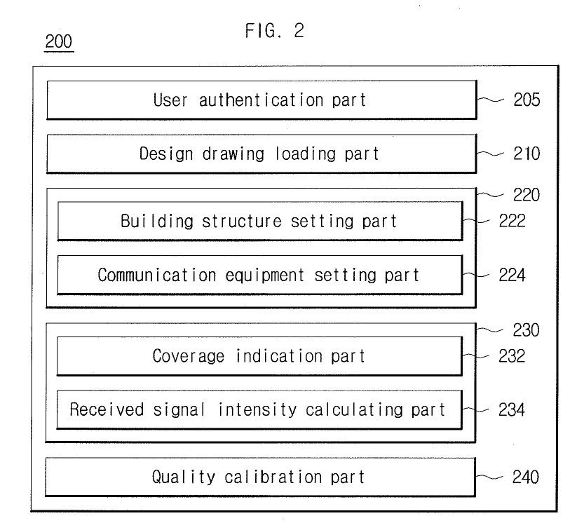

The quality value providing server 300 can include a separate quality value calculation apparatus for helping to effectively arrange communication equipment (or a communication device) (e.g. a repeater) for providing a mobile communication service in the building. The structure of the quality value calculation apparatus will be described later by referring to FIG. 2.

Here, the network can include a mobile communication network, Internet, a dedicated network and a satellite communication network and so on. The terminal 100 can be accessible a network and can be a mobile terminal, a mobile phone, a personal digital assistant (PDA), a desktop PC or a laptop computer, or any other portable computing device and so on.

In the network, the quality value providing server 300 can be connected to a database 400. The database 400 can store user information and information related to the internal structure of a building and equipment to be set up.

If the terminal 100 is assessed, the quality value providing server 300 can request inputting of identification and a password to the terminal 100 or perform the authentication of users through their certificates. Alternatively, other typical authentication method can be used.

The quality value providing server 300 provide the terminal 100 with quality providing GUI (Graphic User Interface). In the quality providing GUI, building information (hereinafter, referred to as BI) for measuring the quality of mobile communication can be stored in advance. The building information can include not only a shape and a type of the internal structure of the building and building attribute information but also a type and an attitude information of communication equipment to be set up to provide the mobile communication service.

The quality value providing server 300 receives variables relating to the mobile communication equipment, which is, in case of the repeater, for example, type of the repeater, set-up position of the repeater, FA and other variables, inputted by a user from the terminal 100. The quality value providing server 300 calculates the coverage and (received signal strength indication (RSSI) or energy of bit/interference of others (Ec/Io) of microwave transmitting/receiving equipment such as antenna based on received variable. The calculated values can be used to display the quality of the mobile communication service in the building. The quality value providing server 300 reflects the calculated values on the quality providing GUI before sending the reflected values to the terminal 100. Alternatively, the quality value providing server 300 can send only graphic data to the terminal 100 to allow the quality of in-building mobile communication service such as the coverage to be displayed in the quality providing GUI.

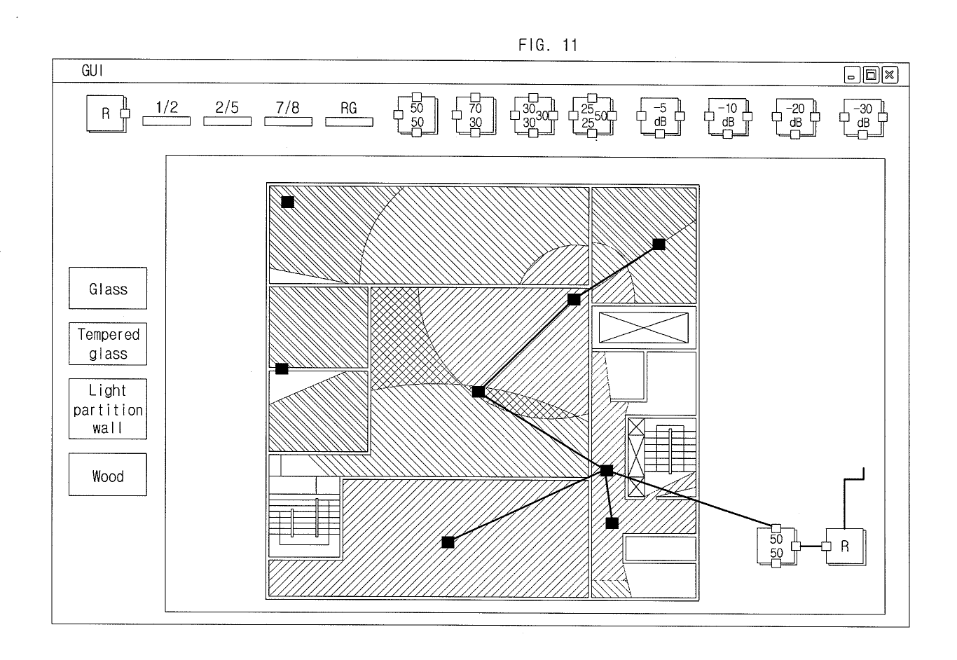

More specifically, the quality value providing server 300 allows the quality value of the mobile communication service to be visually displayed in quality providing GUI by using the calculated coverage, the RSSI or Ec/Io of the pertinent communication equipment. For example, the quality value of the mobile communication service of the building can be marked by allowing the whole area of the building to be divided into sections with different patterns or colors, or the whole area to be marked by using two or three dimensionally divided sections, (e.g. contour lines) depending on the quality. This will be described later in detail with reference to FIG. 11.

The quality value providing server 300 can confirm the capability of the repeater set up in a certain location and allocate an optimal power to effectively calculate the coverage.

FIG. 2 is a block diagram showing an apparatus for calculating a quality value of a mobile communication service in accordance with an embodiment.

A quality value calculation apparatus 200 in accordance with an embodiment can be included in the quality value providing server 300 to provide the terminal 100 with a simulation result of the mobile communication service in the building.

However, it is unnecessary that the quality value calculation apparatus 200 is included in the quality value providing server 300. Alternatively, the value calculation apparatus 200 can be included in the terminal 100. In this case, the quality of the mobile communication service can be simulated in the terminal 100.

The quality value calculation apparatus 200 in accordance with an embodiment can include a user authentication part 205, a building drawing loading part 210, which recognize and display an engineering design of a building, a engineering factor setting part 220, which sets an internal structural objects and mobile communication service providing equipment indicated in the engineering design, and a mobile communication quality value calculation part 230, which calculates the mobile communication quality value according to the internal structural objects and the mobile communication service providing equipment set by the engineering factor setting part 220.

The user authentication part 205 authenticates a user who uses the quality value calculation apparatus 200. The user authentication part 205 authenticates the user by using the typical authentication way with identification and a password or an authentication key. As the result of authenticating, the user authentication part 205 can put a limit on the use of the terminal 100 if the user fails to be permitted to use the quality value calculation apparatus 200.

The building drawing loading part 210 loads an engineering design of a building. A specific design program can make the engineering design of a building capable of being loaded by the building drawing loading part 210. For example, the engineering design can be made in *.dwg file which is made by AutoCAD™ (i.e. a product of AutoCAD co.) or *.wmf or *.jpg which is transformed from the CAD file into an image file.

The building drawing loading part 210 can further include an engineering design converter 214, which covert a typical picture or image file (i.e. a picture of a drawing taken by a digital camera) into an engineering design. The building drawing loading part 210 can perceive darkness and brightness of the picture and re-organize the length and thickness of internal walls of the building into a suitable format of the engineering design. Unlikely, in case that the building drawing loading part 210 can load an image file only, the design drawing converter 214 of the building drawing loading part 210 can covert the engineering design into a typical picture or image file.

Also, The building drawing loading part 210 can further include a scale input part through which a user can input a scale in order to allow an actual distance of the building to be displayed on a screen.

The engineering factor setting part 220 includes a building structure setting part 222, which sets types and attributes of internal objects of the building, and a communication equipment setting part 224, which sets a type and attributes of communication equipment such as a repeater or an antenna for providing the mobile communication service in the building.

A building structure setting part 222 sets the types and attributes of internal structural objects of the building. In particular, the building structure setting part 222 can apply each type and attribute (e.g. the quality of its material) of the structural objects of the building which is selected and inputted by a user through quality providing GUI on the engineering design. This selected and inputted types and attributes can be transmitted and received between the quality value providing server 300 and the terminal 100. The internal structural objects of the building can be at least one of glass, tempered glass, a light-weighted partition wall, wood, brick, steel, concrete, an elevator door. Also, the attitudes of the internal structural objects of the building can be set or defined by at least one of thickness, height, microwave loss value, dielectric constant, electric conductivity and reflective coefficient. The building structure setting part 222 can set the same attributes as the actual attributes of the internal structural objects of the building, which are a thickness, a height, a microwave loss value, a dielectric constant, electric conductivity or reflective coefficient and so on in order to more accurately simulate the quality of the mobile communication service in the building. For example, an outer wall of the building illustrated in the engineering design can be set as concrete and an inner wall as wood.

If the building structure setting part 222 sets the internal structural objects of the building, in the engineering design, different color can be applied depending on each type of the internal structural objects such as wall, door and pillar. The building structure setting part 222 sets each type and attribute of the internal structural objects on the engineering design by the inputted user's selection. For example, if a user draws a red line on the engineering design by using a mouse, the building structure setting part 222 can set a concrete wall on a corresponding area.

The communication equipment setting part 224 sets the types and attributes of the communication equipment of providing the mobile communication service on the engineering design. Here, the communication equipment can be at least one of a repeater, a distributer, an antenna, a feeder cable and mobile station, for providing the mobile communication service in the building or for estimating the quality of the mobile communication. The attributes of the communication equipment can be determined by at least one of type, scale, microwave loss, power gain, bandwidth, radiation pattern, height information, position information and direction information. The communication equipment setting part 224 can set decibel isotropicPerl (DBI) which is one of the types of a repeater. In the case of a PCS, output information can be set and in the case WCDMA, output information and FA frequency assignment (FA) can be set.

The mobile communication quality value calculation part 230 includes a coverage display part 232 that displays a coverage of pertinent communication equipment and a received signal intensity calculating part 234 which displays the intensity of the received and transmitted signals.

The coverage indication part 232 displays the coverage of the communication equipment according to the structural objects and the communication equipment which are set on the engineering design of the building. For example, the coverage indication part 232 can display the coverage in elliptical shapes of the contour lines that have different colors per each antenna when the antenna is set as the communication equipment on the engineering design of the building. The coverage indication part 232 can determine a range of the antenna coverage and apply the different colors according to the determined range.

The received signal intensity calculating part 234 calculates the intensity of signals received by a mobile station on the engineering design. A signal intensity can be represented in a form of RSSI or Eb/Io.

The quality value calculation apparatus 200 in accordance with an embodiment can further include a quality value calibration part 240. The quality value calibration part 240 produces a regressive equation for two input values. One of the two input values indicates the quality value of the mobile communication service (i.e. the coverage and the signal intensity) calculated by the mobile communication quality value calculation part 230, and the other indicates the quality value of the mobile communication service measured inside the building. A formula of calculating the regressive equation can be predetermined.

The quality value calibration part 240 calibrates the calculated quality value of the mobile communication service by using the regressive equation.

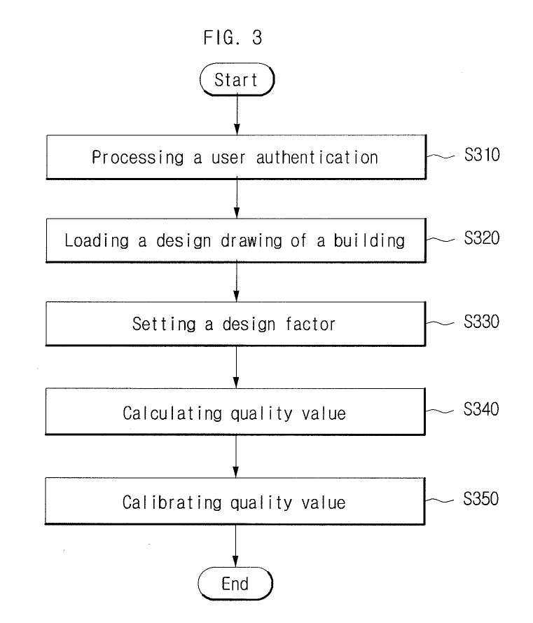

FIG. 3 is a flowchart showing a method for calculating a quality-value of a mobile communication service in a building in accordance with an embodiment.

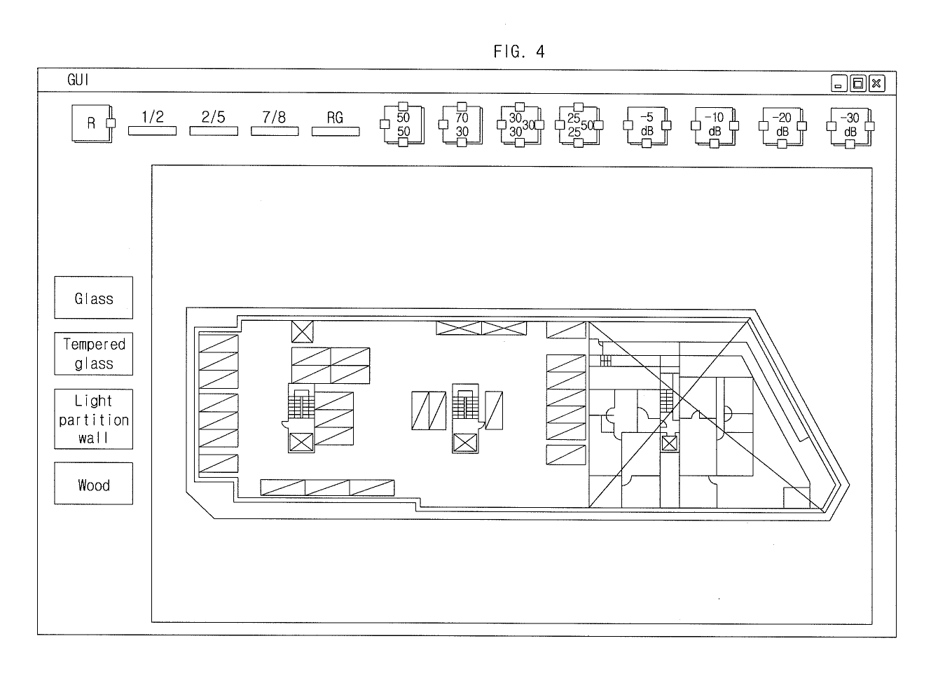

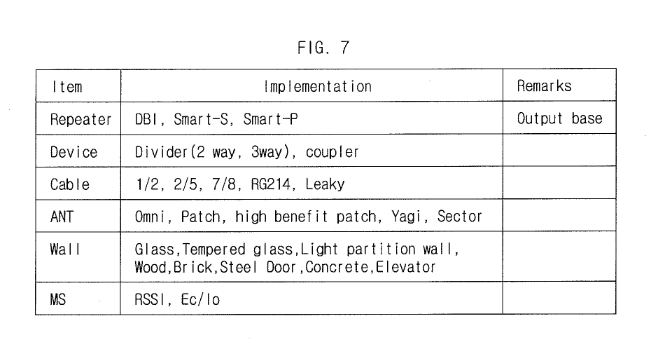

FIG. 4 through FIG. 11 show examples of each step's results displayed on quality providing GUI of the terminal 100. Hereinafter, each step of the method for calculating the quality-value of the mobile communication service in the building in accordance with an embodiment will be described by referring to FIG. 4 to FIG. 11.

Referring to FIG. 3, at a step S310, the quality value calculation apparatus 200 processes the authentication of a user.

At a step S320, the quality value calculation apparatus 200 loads an engineering design of the building for calculating the quality value of the mobile communication service. As described above, the step of loading the engineering design can further include a step of converting the engineering design to an image file. The engineering design is loaded and displayed on the quality providing GUI.

Also, the step of loading the engineering design can further include a step of applying a scale onto the engineering design. For example, if a user inputs a scale or distance into the engineering design, the quality value calculation apparatus 200 reflects the actual distance of the building on quality providing GUI.

Because the quality value calculation apparatus 200 can apply distance or square measurement on the engineering design, the length of a feeder cable to be set later can be estimated and visualized through the extension or contraction of the quality providing GUI.

As the result of the step S320, the engineering design is displayed on the quality providing GUI. The engineering design can be an image file in a form of “jpg” or “wmf,” or an engineering design file that is made by an AutoCAD program. Also, the engineering design can be loaded in any one of the two forms by allowing the forms of “jpg” or “wmf” file and the engineering file to be converted to each other. However, they are merely examples and the quality value calculation apparatus 200 can load various types of files.

Then, the process proceeds to step S330, in which the quality value calculation apparatus 200 sets engineering factors for providing the mobile communication service in the building on the engineering design. Here, the engineering factors include internal structural objects and communication equipment of the building. The step S330 engineering factor can further include a step of each type and attribute of the internal structural objects marked on the engineering design and a step of each type of attribute of the communication equipment for providing the mobile communication service in the building. Even if it is the quality value calculation apparatus 200 that sets engineering factors on the engineering design, the pertinent engineering factors are required to be selected by user's input preferentially.

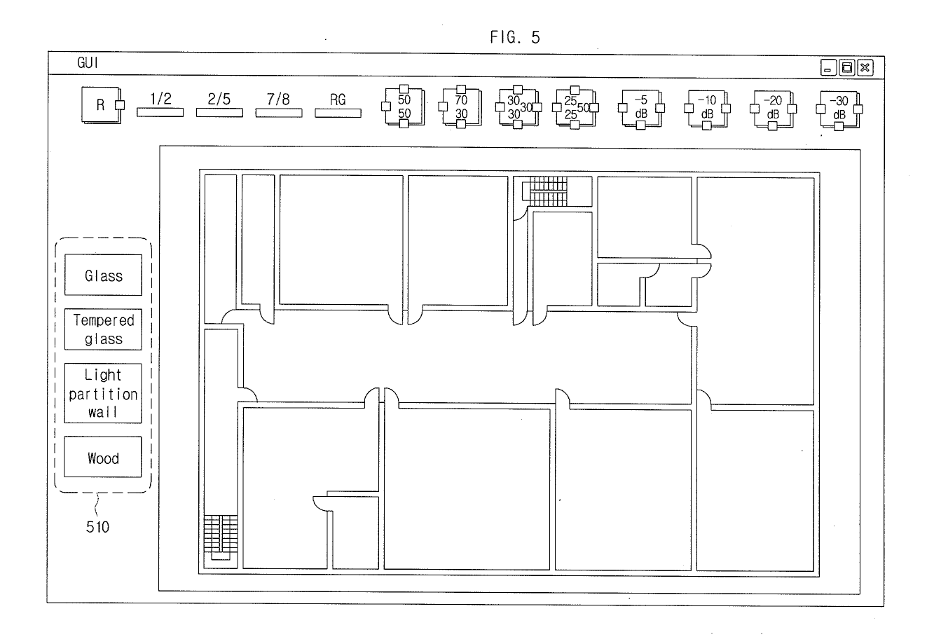

FIG. 5 through FIG. 10 show the quality providing GUI including a separate menu or pop-up window that allows a user to select engineering factors. Below is described the method of selecting the engineering factors set in step the S330.

First, referring to FIG. 5, the quality value calculation apparatus 200 can receive an input of selecting materials of the internal structural objects of the building by allowing a user to apply different colors on the internal structural objects of the building through the quality providing GUI. The materials of the internal structural objects can be at least one of glass, tempered glass, light-weighted partition walls, wood, brick, steel, concrete and elevator doors. If the user points a start point and an end point through dragging a mouse, a line or square can be drawn in a painting board. Also, a separate drawing or painting menu can be formed to have the shape of a tool bar on the quality providing GUI, to thereby allow the user to select the materials by using the menu.

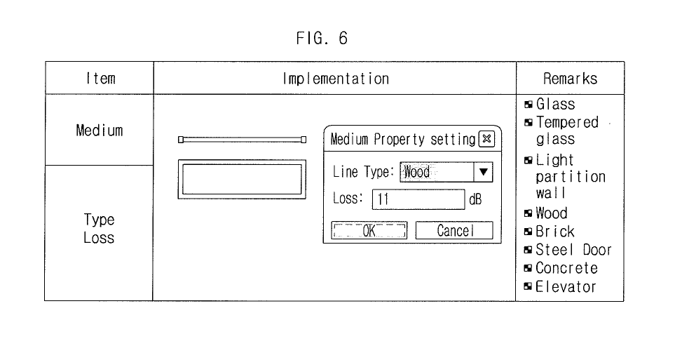

In addition to the aforementioned materials, since the internal structural objects of the building reflect or diffuse, or transmit microwaves if an antenna receives the microwaves, some of the received microwaves are lost. In one embodiment, this loss is considered. In other words, after the internal structural objects are drawn, the simulation can be accurately completed when the attribute such as a microwave loss value is set. Each attribute of the internal structural objects of the building can include at least one of a thickness, a height, a microwave loss value, electric conductivity and a reflective coefficient of the material. The attributes of the internal structural objects of the building can be inputted or selected through the separate sub-menu or pop-up window displayed on the quality providing GUI illustrated in FIG. 6.

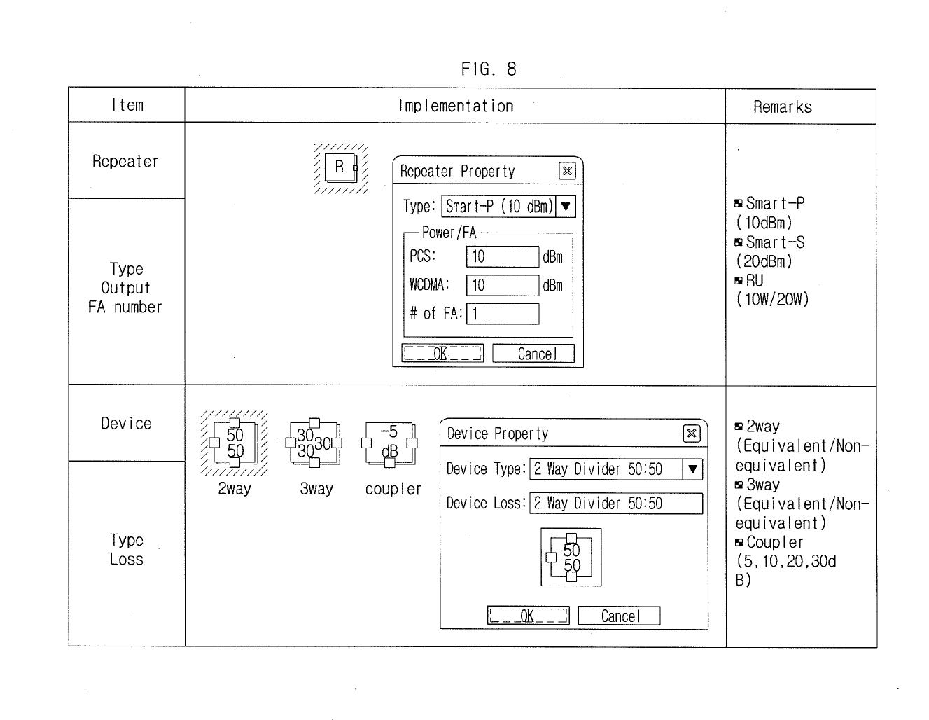

Referring to FIG. 5 to FIG. 7, the quality value calculation apparatus 200 allows the communication equipment for providing the mobile communication service in the building to be drawn on the engineering design through quality providing GUI by the user's menu selection or object selection of the toolbar. In this case, referring to FIG. 8, a type and attribute of the communication equipment can be selected through a separate sub-menu or pop-up window for selecting the communication equipment.

A repeater, one of the communication equipment can be DBI, Smart-S, Smart-P or any other repeater settable in the building, which is generally well known to a person of ordinary skill in this technical field, and can be selected by a user. Also, in the case of the repeater, the attribute of the repeater can be the output of a PCS type, or the output of a WCDMA type, and FA number.

Also, types of distributers can include a two way distributer, a three way distributer, a coupler and any other distributer settable in the building, which is generally well known to a person of ordinary skill in this technical field. Also, in the case of the distributer, the attributes to be set can include a distribution ratio, a loss ratio and so on.

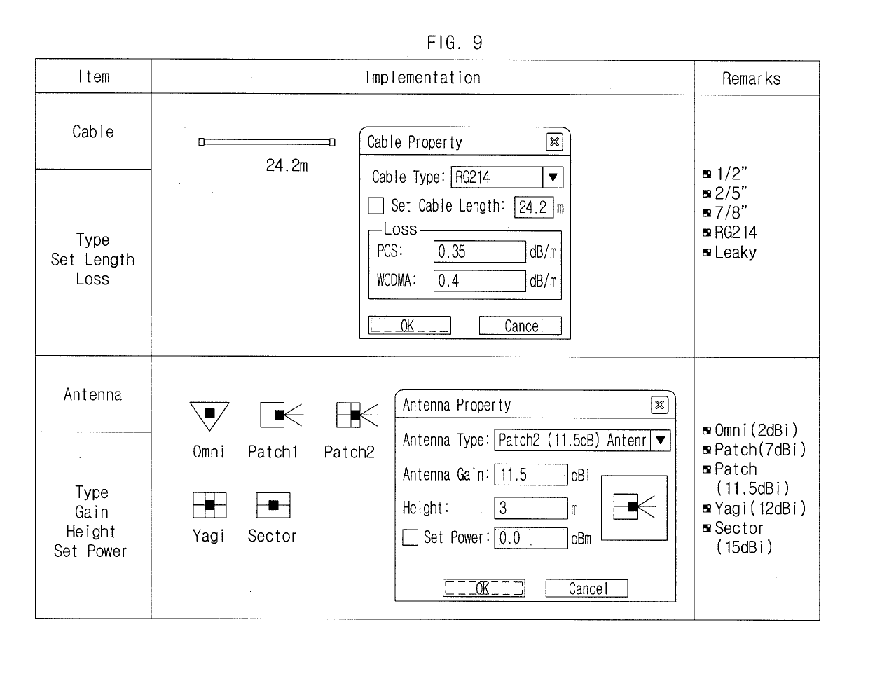

FIG. 9 illustrates a pop-up window or sub-menu for selecting a cable or an antenna as other communication equipment. Referring to FIG. 9, types of a feeder cable can be selected and types of the feeder cable can be ½″, ⅖″, ⅞″, RG214, Lesky and any other feeder cable settable in the building, which is generally well known to a person of ordinary skill in this technical field. Also, in the case of the feeder cable, the attribute to be set includes the actually measured length of the feeder cable, and the loss ratio in case of the PCS type or the WCDMA type.

Also, types of the antenna can include omni, patch, yagi and sector types, and any other antenna settable in the building, which is generally well known to a person of ordinary skill in this technical field. Also, in the case of the antenna, the attribute to be set can include power gain, height, predetermined output, and so on.

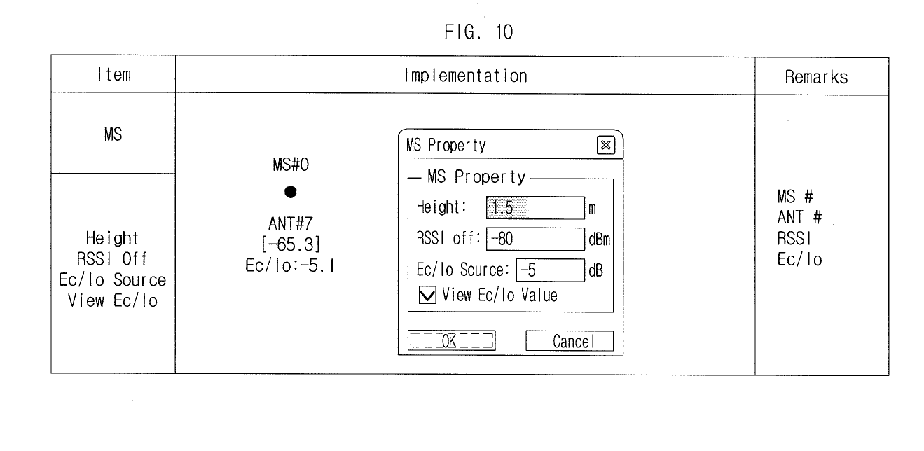

FIG. 10 illustrates a screen for selecting the attribute of a mobile station as other communication equipment. The mobile station is a communication equipment to measure RSSI or Ec/Io. In the case of the mobile station, the attributes to be set can include setting height, RSSI off, Echo source, view Ec/Io value and so on. In more detail, MS #0 indicates an identification number of the mobile station and increases in proportion to the number of the mobile stations. ANT #7 refers to an identification number of an antenna that is influenced by the mobile station when measuring RSSI value. This is marked together with the coverage on the engineering design. [−6.53] refers to an RSSI value measured by the pertinent mobile station. Ec/Io:−5.1 refers to an Ec/Io value that is measured by the mobile station. RSSI off 950 displayed in a window showing the attribute of the mobile station refers to RSSI on condition that a repeater of the mobile station is off and Ec/Io source 960 refers to Ec/Io of a source of a repeater input port.

The attributes of the communication equipment for providing the mobile communication service, which is described with reference to FIG. 8 through FIG. 10, can be inputted by allowing a user to double-click a drawn object or to select the attributes in a new window formed through being selected in a menu. Also, the attributes of the communication equipment can include at least one of type information of the communication equipment to be set, microwave loss information, power gain information, FA information, radiation pattern information, height information, position information and direction information.

Then, if the attribute of the communication equipment is selected and set, the process proceeds to the step S340 of FIG. 3. At the step 340, the quality value calculation apparatus 200 calculates quality-value of the mobile communication service in the building, based on the set engineering factors. The quality value of mobile communication service in the building can be calculated in a form of the microwave coverage of the antenna or the received signal intensity of the mobile station.

FIG. 11 illustrates the simulation result of the calculated microwave coverage of the antenna on an engineering design. Referring to FIG. 11, the microwave coverage of the antenna can be determined when the structure of the building transmits or reflects the microwave. Also, the coverage can be marked in a plurality of elliptical contour lines with different colors or patterns. Here, the different colors or patterns are used to distinguish the coverage per each antenna.

Then, at the step S350, the quality value calculation apparatus 200 compares the calculated quality value of mobile communication service with the actually measured quality value of the mobile communication service by a user of the terminal 100 in order to produce a regressive equation. Alternatively, by inputting two predetermined values into a regressive equation having the two predetermined values as description variables and a calibration value as an estimated variable, the quality value calculation apparatus 200 calculates the calibration value and calibrates the quality value of the mobile communication service based on the calculated calibration value.

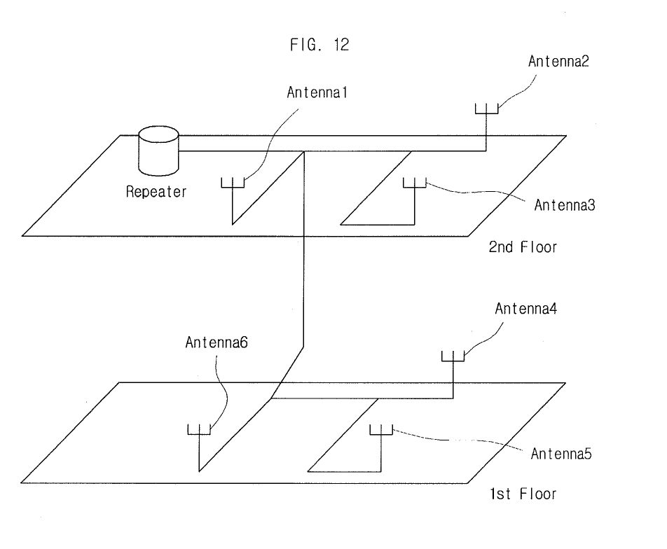

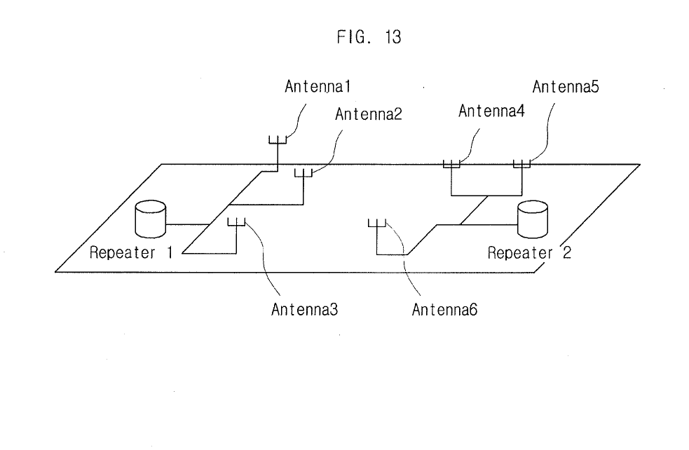

FIG. 12 and FIG. 13 are engineering designs showing a building where an apparatus for calculating a quality value of a mobile communication service in a building is used in the building in accordance with an embodiment.

In particular, FIG. 12 shows a building having a first story and a second story and a repeater is set only on the second story. In this case, since one repeater is set only in the left area, antennas that are connected by using feeder cables should be set and arranged in the remaining area.

The quality value calculation apparatus 200 can load the engineering design of both the first story and the second story. Alternatively, engineering designs of the first story and the second story, respectively, can be converted to the design of each story according to user's selection.

As described with reference to FIG. 3, the quality value calculation apparatus 200 receives the setting of a building structure and the selection of communication equipment such as a repeater, distributor or antenna and sets the received setting and selection on the drawing in order to calculate the quality value of the mobile communication service in the building. However, in the case of the multi story like this, the quality value calculation apparatus 200 can further receive the selection of thickness and material of a bottom or ceiling and set the received selection on the engineering design.

The calculated antenna coverage can be marked in different colors or patterns on the engineering design as described with reference to FIG. 11.

FIG. 13 illustrates the case of a simple story having at least one repeater. In the case of FIG. 13, because two repeaters are set in one story and different simulation result may be caused.

Therefore, the quality value calculation apparatus 200 can further receive the number of repeaters and position of each repeater and reflect them on the engineering design in order to calculate the coverage of the antenna and the received signal intensity of the mobile station.

In the case of the engineering design of N stories, which is not shown, the repeaters in the different quantities may be set on each of the N stories. Alternatively, the repeaters in the identical or different quantities may be set on some of the N stories. This is because each of the N stories of the building has a different structure. The different types and attributes of the different structure may cause the coverage and so on of the communication equipment to be changed.

In this case, as described above, the drawing of N stories can be loaded simultaneously or at a different time, and the types and attributes of each building structure and the number, types and attributes of the repeaters can be set on the drawing of the pertinent store, to thereby calculate the quality value of the mobile communication service.

One embodiment includes a computer readable medium, such as a CD-ROM, an RAM, an ROM, a hard disk and a magneto-optical disk, which stores instructions, when executed, performing the above described methods.

At least one of the disclosed embodiments can check the capability of the equipment set up in a pertinent place and allocate the optimal power by visualizing the quality of a mobile communication service in order to efficiently compute the coverage.

At least one of the disclosed embodiments can also estimate the influence on the change of the capability of a repeater, a building's internal structure and various other devices in order to make the easy application depending on how much the surroundings of the mobile communication is changed.

In addition, at least one of the disclosed embodiments can consistently set up repeaters in a building in consideration of various variables such as changeable engineer's engineering methods and design trends.

Furthermore, at least one of the disclosed embodiments can increase the understanding of an actual field status of a site by visualizing the influence on the change of the mobile communication performance in a building and provide an accurate and quick material for determining whether more equipment is necessary, to thereby manage the building more efficiently.

Moreover, at least one of the disclosed embodiments can decrease an engineering error of mobile communication equipment in a building and the possibility of being re-set up due to the lack of the coverage, to thereby reduce the equipment cost.

Although only certain embodiments have been described, it is appreciated that various permutations, substitutions, and modifications are possible without departing from the scope of the appended claims.

What is claimed is:

1. A method of calculating a quality-value of a mobile communication service in a building, the method comprising:
loading an engineering design of the building into a memory of a computing device having a graphic user interface (GUI);
applying an engineering factor which influences a quality of the mobile communication service on the engineering design when a communication device, configured to provide the mobile communication service, is set up in the building; and
calculating, with a processor of the computing device, the quality-value of the mobile communication service based on the applied engineering factor.

2. The method of claim 1, wherein the loading comprises converting the engineering design of the building to an image file.

3. The method of claim 1, wherein the loading comprises applying scale information that is received via the GUI.

4. The method of claim 1, further comprising authenticating a user of an apparatus for calculating the quality value in the building before the loading.

5. The method of claim 1, wherein, if the communication device is set in the building, the applying comprises:
applying types and attributes of internal structural objects of the building to the engineering design; and
applying types and attributes of the communication device to the engineering design.

6. The method of claim 5, wherein the internal structural objects of the building is marked in any one of different patterns, different colors and a combination thereof according to the types of the internal structural objects.

7. The method of claim 5, wherein the types and attributes of the internal structural objects of the building are selected by user's selection received via the GUI.

8. The method of claim 5, wherein, if a menu displayed on the GUI or an object of a toolbar is selected or moved on the GUI by a user, the communication device is marked in the engineering design.

9. The method of claim 5, wherein the types and attributes of the communication device are selected by user's selection received via the GUI.

10. The method of claim 1, wherein the calculating comprises displaying a coverage of the communication device.

11. The method of claim 10, wherein the displaying comprises marking the coverage of the communication device on the engineering design in a form of an elliptical contour line.

12. The method of claim 1, wherein the calculating comprises calculating a received signal intensity of the communication device.

13. The method of claim 12, wherein the calculating comprises marking the received signal intensity around the communication device marked on the engineering design.

14. The method of claim 1, further comprising producing a regressive equation based on the calculated quality-value of the mobile communication service and an actually measured value and the calibration of the quality-value of the mobile communication service with the use of the regressive equation, after calculating the quality-value of the mobile communication service.

15. The method of claim 1, wherein the engineering design is an engineering design of a single story or a plurality of stories, and wherein the applying comprises, if a plurality of communication devices are set on the single story or each of the plurality of stories, applying the engineering factor which influences the quality of the mobile communication service to the engineering design.

16. The method of claim 1, wherein the engineering design is an engineering design of a plurality of stories, and wherein the applying comprises, if one communication device is set on the plurality of stories of the building, applying the engineering factor which influences the quality of the mobile communication service to the engineering design.

17. The method of claim 1, wherein the engineering design is an engineering design of N stories, and wherein the applying comprises, if i) a different number of communication devices are set on each of the N stories or ii) the same number or a different number of communication devices are set up on some of the N stories, applying the engineering factor which influences the quality of the mobile communication service to the engineering design.

18. The method of claim 1, wherein the communication device includes at least one of a repeater, a distributer, an antenna, a feeder cable and a mobile station.

19. An apparatus for calculating a quality-value of a mobile communication service, the apparatus comprising:
a engineering design loading unit configured to load an engineering design of the building on a graphic user interface (GUI) of a computing device;
a engineering factor setting unit configured to apply an engineering factor which influences a quality of the mobile communication service on the engineering design when a communication device configured to provide the mobile communication service is set up in the building; and
a mobile communication quality value calculation unit configured to calculate the quality-value of the mobile communication service based on the applied engineering factor,
wherein at least one of the engineering design loading unit, engineering factor setting portion loading unit, and mobile communication quality value calculation unit comprises a hardware device.

20. The apparatus of claim 19, wherein the engineering design loading unit comprises an engineering design converter configured to convert the engineering design to an image file or the image file to the engineering design.

21. The apparatus of claim 19, wherein the engineering factor setting unit comprises:
a building structure setting portion configured to set types and attributes of internal structural objects of the building; and
a communication device setting portion configured to set types and attributes of a communication device which is configured to provide the mobile communication service.

22. The apparatus of claim 21, wherein a material of the internal structural object of the building comprises at least one of glass, tempered glass, a light-weighted partition wall, wood, brick, steel, concrete and elevator door.

23. The apparatus of claim 21, wherein the attribute of the internal structural object of the building comprises at least one of a thickness, a height, a microwave loss value, a dielectric constant, an electric conductivity and a reflective coefficient of the internal structural object.

24. The apparatus of claim 21, wherein the type of the communication device comprises at least one of a repeater, a distributer, an antenna, a feeder cable and a mobile station.

25. The apparatus of claim 21, wherein the attribute of the communication device comprises at least one of a type, a scale, a microwave loss, a power gain, a bandwidth, a radiation pattern, a height, a location and a direction.

26. The apparatus of claim 19, wherein the mobile communication quality value calculation unit comprises a coverage indication portion configured to display a coverage of an antenna, and wherein the coverage indication portion is incorporated in the communication device.

27. The apparatus of claim 19, wherein the mobile communication quality value calculation unit comprises a received signal intensity calculating portion configured to calculate a received signal intensity value of a mobile station, and wherein the received signal intensity calculating portion is incorporated in the communication device.

28. The apparatus of claim 27, wherein the received signal intensity value comprises at least one of received signal strength indicator (RSSI) or energy of bit/interference of others (Ec/Io).

29. The apparatus of claim 19, wherein the apparatus is incorporated in a user terminal or a server.

30. The apparatus of claim 29, wherein the user terminal comprises one of the following: a mobile terminal, a mobile phone, a personal digital assistant (PDA), a desktop PC, a laptop computer or a portable computing device.

31. A system for providing a quality-value of a mobile communication service in a building, the system comprising:
a quality value providing server configured to calculate and provide the quality-value of the mobile communication service; and
a user terminal configured to access the quality value providing server and output an engineering design on a screen, and if a communication device, configured to provide a mobile communication service, is set in the building, to receive the quality value of the mobile communication service by setting the engineering factor which influences on a quality of the mobile communication service on an engineering design and transmitting the set engineering factor to the quality value providing server.

32. The system of claim 31, wherein the user terminal comprises one of the following: a mobile terminal, a mobile phone, a personal digital assistant (PDA), a desktop PC, a laptop computer or a portable computing device.

33. A non-transitory computer readable medium storing instructions, when executed, to perform a method of providing a quality-value of a mobile communication service, the method comprising:
loading an engineering design of the building into a memory of a computing device having a graphic user interface (GUI);
applying an engineering factor which influences a quality of the mobile communication service on the engineering design when a communication device, configured to provide the mobile communication service, is set up in the building; and
calculating, with a processor of the computing device, the quality-value of the mobile communication service based on the applied engineering factor.

34. A system for calculating a quality-value of a mobile communication service in a building, the system comprising:
means for loading an engineering design of the building into a memory of a computing device having a graphic user interface (GUI);
means for applying an engineering factor which influences a quality of the mobile communication service on the engineering design when a communication device, configured to provide the mobile communication service, is set up in the building; and
means for calculating, with a processor of the computing device, the quality-value of the mobile communication service based on the applied engineering factor.
